(19) United States
(12) Patent Application Publication
(10) Pub. No.: US 2025/0296570 A1
(43) Pub. Date: Sep. 25, 2025

(54) VEHICLE CONTROL DEVICE AND VEHICLE CONTROL COMPUTER PROGRAM

(71) Applicant: TOYOTA JIDOSHA KABUSHIKI KAISHA, Toyota-shi Aichi-ken (JP)

(72) Inventor: Yuko Izumi, Shibuya-ku Tokyo-to (JP)

(73) Assignee: TOYOTA JIDOSHA KABUSHIKI KAISHA, Toyota-shi Aichi-ken (JP)

(21) Appl. No.: 19/083,793

(22) Filed: Mar. 19, 2025

(30) Foreign Application Priority Data
Mar. 21, 2024 (JP) 2024-044993

(51) Int. Cl. B60W 30/18; G06V 20/56; G06V 20/58

(52) U.S. Cl. CPC B60W 30/18163; G06V 20/584; G06V 20/588; B60W 2420/403; B60W 2552/53; B60W 2554/406; B60W 2554/802

(57) ABSTRACT

The vehicle control device includes a processor configured to: determine whether or not a host lane in which a host vehicle is traveling is a merging lane merging with a main lane, detect a vehicle ahead traveling in front of the host vehicle in the merging lane when the host lane is the merging lane, wait for execution of lane change control for moving the host vehicle from the merging lane to the main lane while the vehicle ahead is detected in the merging lane, and execute the lane change control when the vehicle ahead is not detected or after the vehicle ahead is moved to the main lane.

### CROSS-REFERENCE TO RELATED APPLICATIONS

This application claims priority to Japanese Patent Application No. 2024-044993 filed Mar. 21, 2024, the entire contents of which are herein incorporated by reference.

### FIELD

The present disclosure relates to a vehicle control device and a computer program for controlling a vehicle, which automatically execute merging control.

### BACKGROUND

With respect to automated merging control for a vehicle, it has been proposed to set a lane change section in which a lane change is automatically performed in a case where a main lane is congested, closer to the end of a merging lane in which a host vehicle is traveling than in a case where the main lane is not congested (see Japanese Unexamined Patent Publication JP2023-119561A).

### SUMMARY

It is known that, in a road section in which the number of lanes decreases (hereinafter referred to as a merging section), a vehicle traveling in a merging lane and a vehicle traveling in a main lane alternately merge one by one near the end of the merging lane (referred to as a zipper merge), thereby suppressing deterioration of traffic congestion and occurrence of an accident.

It is an object of the present disclosure to provide a vehicle control device that can cause a host vehicle to perform a zipper merge.

The vehicle control device provided by one embodiment includes a processor configured to: determine whether or not a host lane in which a host vehicle is traveling is a merging lane merging with a main lane, detect a vehicle ahead traveling in front of the host vehicle in the merging lane when the host lane is the merging lane, wait for execution of lane change control for moving the host vehicle from the merging lane to the main lane while the vehicle ahead is detected in the merging lane, and execute the lane change control when the vehicle ahead is not detected or after the vehicle ahead moves to the main lane.

The vehicle control device according to the present disclosure has an effect of being able to cause a host vehicle to perform a zipper merge.

### BRIEF DESCRIPTION OF DRAWINGS

FIG. 1 schematically illustrates the configuration of a vehicle control system in which a vehicle control device is mounted.

FIG. 2 illustrates the hardware configuration diagram of an electronic control unit, which is an embodiment of a vehicle control device.

FIG. 3 is a functional block diagram of a processor of the electronic control unit, related to a vehicle control process.

FIG. 4A is a schematic explanatory diagram of the vehicle control process.

FIG. 4B is a schematic explanatory diagram of the vehicle control process.

FIG. 4C is a schematic explanatory diagram of the vehicle control process.

FIG. 5 is an operation flowchart of the vehicle control process.

### DESCRIPTION OF EMBODIMENTS

Hereinafter, a vehicle control device, a vehicle control method executed on the vehicle control device, and a computer program for vehicle control will be described with reference to the drawings. When a lane on which a host vehicle is traveling is a merging lane which merges with a main lane, the vehicle control device waits for execution of lane change control for moving the host vehicle from the merging lane to the main lane while a vehicle ahead traveling in front of the host vehicle is detected in the merging lane. The vehicle control device executes the lane change control after the vehicle ahead moves to the main lane or when the vehicle ahead is not detected.

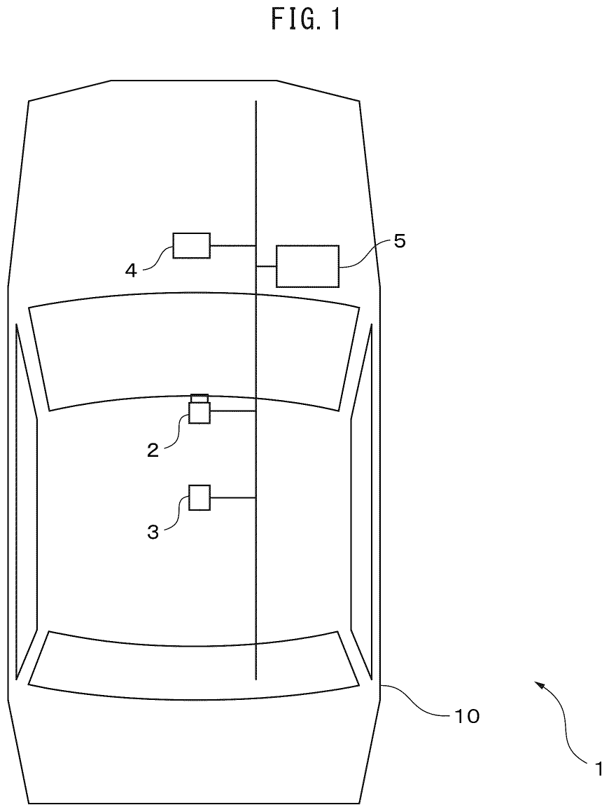

FIG. 1 is a schematic configuration diagram of a vehicle control system in which a vehicle control device is mounted. In the present embodiment, the vehicle control system 1, which is mounted on the vehicle 10 and controls the vehicle 10, includes a camera 2, a GPS receiver 3, a storage device 4, and an electronic control unit (ECU) 5, which is an example of the vehicle control device. The vehicle 10 is an example of the host vehicle. The camera 2, the GPS receiver 3, and the storage device 4 are communicably connected to the ECU 5 via an in-vehicle network. The vehicle control device 1 may further include a range sensor (not shown) that measures a distance to an object in an area around the vehicle 10, such as a LiDAR or a radar. The vehicle control system 1 may further include a wireless communication terminal (not shown) that communicates with other devices.

The camera 2 is an example of a sensor that detects a situation around the vehicle 10, and is provided to take pictures of a predetermined area around the vehicle 10 at predetermined capturing period (for example, 1/30 to 1/10 seconds) and generate an image representing the predetermined area. For example, the camera 2 is mounted in the vehicle interior of the vehicle 10 to be oriented in a front direction of the vehicle 10 so as to capture a front area of the vehicle 10 and generates an image in which the front area is represented. The image generated by the camera 2 is an example of a sensor signal. The vehicle 10 may be provided with a plurality of cameras taking pictures in different orientations or having different focal lengths. For example, the vehicle 10 may be provided with a camera for capturing a front area of the vehicle 10 and a camera for capturing a rear area of the vehicle 10. In some embodiments, one or more cameras 2 (and a range sensor) are provided in the vehicle 10 so that the entire periphery of the vehicle 10 can be captured by the plurality of cameras 2 or the one or more cameras 2 and a range sensor. Each time an image is generated, the camera 2 outputs the generated image to the ECU 5 via the in-vehicle network.

The GPS receiver 3 receives GPS signals from GPS satellites at predetermined intervals, and determines the position of the vehicles 10 based on the received GPS signals. Then, the GPS receiver 3 outputs, to the ECU 5 via the in-vehicle network, the positioning information representing the determination result of the position of the vehicle 10 based on the GPS signals at predetermined intervals. Instead of the GPS receiver 3, the vehicle 10 may include a receiver that receives positioning signals from satellites of other satellite positioning systems to determine the position of the vehicle 10.

The storage device 4 is an example of a storage unit, and includes, for example, a hard disk device, a nonvolatile semiconductor memory, an optical recording medium, and an access device thereof. The storage device 4 stores map information used for vehicle control. The map information includes information indicating a merging section in which a merging lane merges with a main lane, the merging section being included in a predetermined region represented in the map information. Further, the map information includes information representing the number of lanes in the individual road sections included in the predetermined region, the width of each lane, and the features existing in or around the individual road sections. The features represented by the map information include road markings such as lane division lines, various road signs, and structures such as curbstones, guardrails, and poles.

Further, the storage device 4 may include a processor for executing a process related to a map information update process and a map information read request. Each time the vehicle 10 moves by a predetermined distance, the storage device 4 may transmit a request for acquiring map information to a map server (not shown) via the wireless communication terminal together with the current position of the vehicle 10. Then, the storage device 4 may receive map information about a predetermined region around the current position of the vehicle 10 from the map server via the wireless communication terminal. In addition, upon receiving a request to read the map information from the ECU 5, the storage device 4 cuts out an area that includes the current position of the vehicle 10 and is relatively narrower than the predetermined region from the stored map information, and outputs the map information of the area to the ECU 5 via the in-vehicle network.

The ECU 5 executes autonomous driving control of the vehicle 10 or executes driving support for the driver of the vehicle 10. In the present embodiment, the ECU 5 executes a vehicle control process for automatically moving the vehicle 10 from a merging lane to a main lane when the vehicle 10 travels on the merging lane in a merging section, as an example of the autonomous driving control or the driving support.

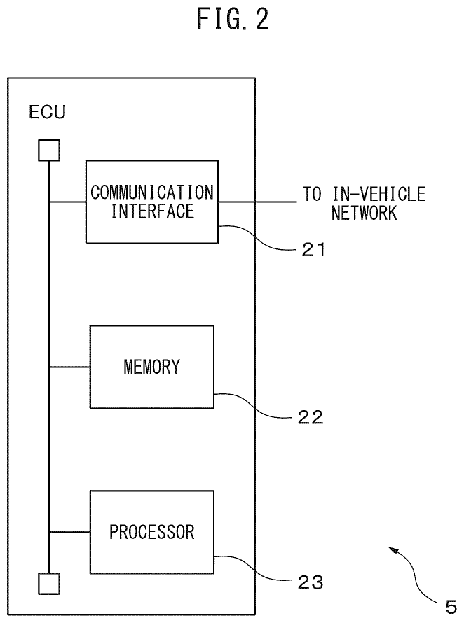

FIG. 2 illustrates the hardware configuration of the ECU 5. As shown in FIG. 2, the ECU 5 includes a communication interface 21, a memory 22, and a processor 23. The communication interface 21, the memory 22, and the processor 23 may each be configured as separate circuits or may be integrally configured as a single integrated circuit.

The communication interface 21 includes an interface circuit for connecting the ECU 5 to the in-vehicle network. The communication interface 21 passes the image received from the cameras 2 and the positioning information received from the GPS receiver 3 to the processor 23. Further, the communication interface 21 passes the map information read from the storage device 4 to the processor 23. Furthermore, the communication interface 21 transmits various kinds of information received by the wireless communication terminal from other devices and a ranging signal received from the ranging sensor to the processor 23.

The memory 22 is another example of a storage unit, and includes, for example, a volatile semiconductor memory and a non-volatile semiconductor memory. The memory 22 stores various types of data used in the vehicle control process executed by the processor 23. For example, the memory 22 stores parameters of the camera 2 such as the focal length, the imaging direction, and the mounted position, and various parameters for identifying a classifier used to detect an object around the vehicle 10. Further, the memory 22 temporarily stores positioning information, images around the vehicle 10, ranging signals, map information, and various data generated during the vehicle control process.

The processor 23 comprises one or more central processing units (CPUs) and a peripheral circuit thereof. The processor 23 may further include another operating circuit, such as a logic-arithmetic unit, an arithmetic unit, or a graphics processing unit. Then, the processor 23 executes the vehicle control process on the vehicle 10.

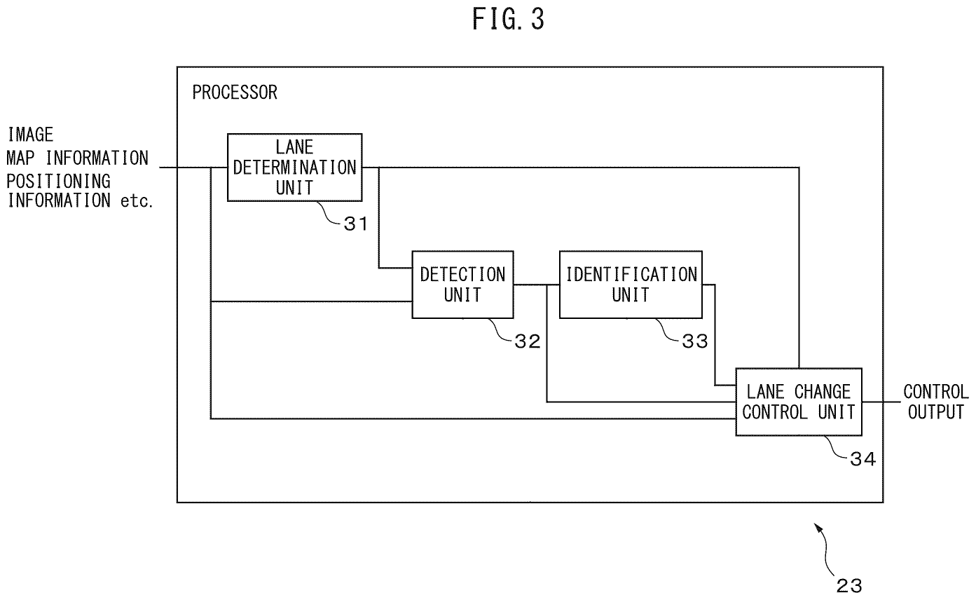

FIG. 3 is a functional block diagram of the processor 23, related to the vehicle control process. The processor 23 includes a lane determination unit 31, a detection unit 32, an identification unit 33, and a lane change control unit 34. Each of these units included in the processor 23 is a functional module, for example, implemented by a computer program executed by the processor 23. Alternatively, each of these units included in the processor 23 may be a dedicated operating circuit provided in the processor 23.

The lane determination unit 31 determines whether or not the vehicle 10 is traveling in a merging section. Further, when the vehicle 10 is traveling in the merging section, the lane determination unit 31 determines whether or not the lane in which the vehicle 10 is traveling (hereinafter, may be referred to as “host lane”) is a merging lane merging with a main lane. The merging section may be, for example, a section in which a merging lane from an interchange or a service area merges with a main lane in a dedicated road. Alternatively, the merging section may be a road section in which the number of lanes decreases due to lane restrictions caused by the structure or construction of the road. In this case, a lane that disappears at a certain point is a merging lane, and a lane adjacent to the merging lane and to which a vehicle traveling in the merging lane can move is a main lane.

The lane determination unit 31 refers to the current position of the vehicle 10 represented by the latest positioning information and the map information in order to determine whether or not the vehicle 10 is traveling in the merging section. Then, the lane determination unit 31 identifies a road section including the current position of the vehicle 10 among the individual road sections represented by the map information as a road section in which the vehicle 10 is traveling. The lane determination unit 31 determines that the vehicle 10 is traveling in the merging section when the identified road section is the merging section, and determines that the vehicle 10 is not traveling in the merging section when the identified road section is not the merging section.

When the vehicle 10 is traveling in the merging section, the lane determination unit 31 determines whether or not the host lane on which the vehicle 10 is traveling is a merging lane. To this end, the lane determination unit 31 refers to the current position of the vehicle 10 represented by the latest positioning information and the map information, and identifies the lane including the current position of the vehicle 10 as the host lane. Then, the lane determination unit 31 determines that the host lane is a merging lane when the identified lane is the merging lane. On the other hand, when the identified lane is different from a merging lane, the lane determination unit 31 determines that the host lane is not the merging lane.

Note that the lane determination unit 31 may estimate the current position of the vehicle 10 by matching the latest image obtained by the camera 2 with the map information. In this case, the lane determination unit 31 detects individual features existing around the vehicle 10 from the image, and projects the detected individual features onto the map information assuming the position and the posture of the vehicle 10. Then, the lane determination unit 31 calculates the degree of matching between each feature detected from the image and the corresponding feature represented on the map information (for example, the sum of squares of the distance between the detected individual feature and the corresponding feature on the map information or the inverse of the sum). The lane determination unit 31 estimates, as the current position and posture of the vehicle 10, the position and posture of the vehicle 10 when the detected individual feature and the corresponding feature represented on the map information most match with each other while variously changing the assumed position and posture of the vehicle 10. In this case also, the lane determination unit 31 may refer to the map information to identify the lane including the current position of the vehicle 10 as the host lane, and may determine whether or not the identified host lane is the merging lane.

Note that the lane determination unit 31 detects each feature represented in the image by inputting an image to a classifier learned in advance so as to detect the feature. Such a classifier may be a deep neural network (DNN) with a convolutional neural network (CNN) type architecture, such as Faster R-CNN or Single Shot MultiBox Detector (SSD). Alternatively, such a classifier may be a DNN with attention mechanisms, such as Vision Transformer. The classifier is learned in advance according to a predetermined learning method such as an error back propagation method using a large number of teacher images representing a feature to be detected.

Further, the lane determination unit 31 may determine whether or not there is a section on which lane restriction is in place based on the traffic information received via the wireless communication terminal. When the lane restriction is in place, the lane determination unit 31 may detect a section with a predetermined length closer to the vehicle 10 than the section on which the lane restriction is in place as a merging section. Alternatively, the lane determination unit 31 may detect a signboard indicating that the travel of any lane is restricted or a road sign indicating that the number of lanes is reduced from the image obtained by the camera 2. When such a signboard or a road sign is detected, the lane determination unit 31 may detect, as a merging section, a section with a predetermined length on the near side with a point of the lane restriction indicated by the signboard or a point indicated by the road sign at which the number of lanes decreases as an end point of the merge section. When the current position of the vehicle 10 is included in the merging section, the lane determination unit 31 determines that the vehicle 10 is traveling in the merging section. In this case, the lane determination unit 31 identifies the host lane as described above, and determines that the lane on which the vehicle 10 is traveling is the merging lane when the identified host lane is a lane in which the vehicle 10 cannot travel beyond the end of the merging section due to lane regulation or construction.

The lane determination unit 31 can detect a signboard or a road sign by inputting an image to a classifier learned in advance so as to detect such a signboard or a road sign. As such a classifier, the lane determination unit 31 can use a classifier similar to the classifier for detecting features described above. Alternatively, the classifier for detecting features may be learned in advance to also detect a signboard or a road sign.

The lane determination unit 31 notifies the detection unit 32 and the lane change control unit 34 of the determination result when it is determined that the vehicle 10 is traveling in the merging section and the host lane is the merging lane.

The detection unit 32 detects one or more vehicles ahead of the vehicle 10 in the merging lane that is the host lane. To this end, the detection unit 32 detects another vehicle traveling around the vehicle 10 and a lane division line by inputting an image generated by the camera 2 when it is determined that the vehicle 10 is traveling in the merging lane to a classifier learned in advance so as to detect the other vehicle and the lane division line. As such a classifier, the detection unit 32 can use a classifier similar to the classifier for detecting features described above. Further, pixels on the image correspond one-to-one to bearings from the camera 2. Therefore, the detection unit 32 identifies the other vehicle represented at the position on the image corresponding to the forward direction of the vehicle 10 as the vehicle ahead. Alternatively, the detection unit 32 sets an area sandwiched between the two lane division lines closest to the vehicle 10 in the image as an area corresponding to the host lane, that is, the merging lane. Then, the detection unit 32 determines whether or not the lower end of the object region in which the other vehicle is represented is included in the area corresponding to the merging lane for each of the detected other vehicles. Among the detected other vehicles, the detection unit 32 may identify, as the vehicle ahead, the vehicle which is represented in the object region whose lower end is included in the area corresponding to the merging lane at a predetermined ratio (for example, 70% to 90%) or more.

Furthermore, the detection unit 32 identifies another vehicle traveling in the main lane among the detected other vehicles. At this time, the detection unit 32 refers to the map information and determines whether the main lane is the right lane or the left lane of the merging lane. Alternatively, the detection unit 32 may determine whether the main lane is the right lane or the left lane of the merging lane according to the positional relationship between the merging lane and the main lane indicated by the detected road sign, the detected signboard or the received traffic information. Then, the detection unit 32 specifies the lane division line on the main lane side among the two lane division lines that divide the host lane as the lane division line between the merging lane and the main lane. Further, among the detected other vehicles, the detection unit 32 identifies, as the vehicle traveling in the main lane, the other vehicle located on the main lane side of the lane division line between the merging lane and the main lane and located within a predetermined distance from the lane division line.

In addition, in a case where a range sensor is mounted on the vehicle 10, the detection unit 32 may detect another vehicle based on a ranging signal generated by the range sensor when it is determined that the vehicle 10 is traveling in the merging lane. In this case, the detection unit 32 may detect another vehicle by inputting the ranging signal to a classifier learned in advance so as to detect the other vehicle from the ranging signal. Such a classifier can be DNN with CNN or attention mechanisms as well as when detecting another vehicle from an image. The detection unit 32 may identify the vehicle ahead or the vehicle traveling in the main lane among the detected other vehicles based on the detected azimuth and distance to the individual detected other vehicles represented by the ranging signal. At this time, the detection unit 32 sets, as the vehicle ahead, the other vehicle whose distance in the lateral direction orthogonal to the traveling direction of the vehicle 10 is equal to or less than a predetermined distance (for example, half of the width of the host lane) among the detected other vehicles. Further, the detection unit 32 identifies the vehicle whose distance in the lateral direction is equal to or more than a predetermined distance and equal to or less than twice the predetermined distance, and whose detected azimuth is a direction toward the main lane, as the vehicle traveling in the main lane.

The detection unit 32 notifies the identification unit 33 and the lane change control unit 34 of the detection result of the vehicle ahead and the information indicating the object region on the image in which the vehicle ahead is represented or the azimuth to the vehicle ahead. Furthermore, the detection unit 32 notifies the lane change control unit 34 of the detection result of the other vehicle traveling in the main lane and the information indicating the object region on the image in which the other vehicle is represented or the azimuth to the other vehicle.

The identification unit 33 identifies a lighting state of lights provided with the vehicle ahead, in particular, brake lights and hazard lights. For this purpose, the identification unit 33 inputs an object region in which the vehicle ahead is represented in each of the images of the time series obtained by the camera 2 to a classifier (hereinafter referred to as a lighting state classifier) for identifying the lighting state in chronological order, while the vehicle ahead is being detected. In a case where the vehicle ahead is detected based on the ranging signal, for each of ranging signals obtained in time series, the identification unit 33 may set the region which corresponds to the azimuth and the range in the ranging signal in which the vehicle ahead is represented and is included in the image generated at the timing closest to the generation timing of the ranging signal, as the object region. Then, the identification unit 33 identifies whether the brake lights and the hazard lights of the vehicle ahead are turned on or off according to the output result of the lighting state classifier.

The identification unit 33 may use a recursively structured DNN, for example, a recurrent neural network (RNN) or a LSTM, as the lighting state classifier. This makes it possible to accurately identify the lighting state of the lights whose appearance can change in time series.

The identifying unit 33 may resize the object region of each of the images to a predetermined size (for example, 32×32) by executing a size converting process such as down-sampling, up-sampling, or bicubic interpolation. The identification unit 33 may input the resized object region to the lighting state classifier. Thus, even if the relative distance between the vehicle 10 and the vehicle ahead changes in time series and the size of the vehicle ahead on the image changes, the lighting state classifier can treat the object region as a constant size. Therefore, the configuration of the lighting state classifier is simplified.

In addition, in a case where a plurality of vehicles ahead are detected, the identification unit 33 may identify the lighting state of the vehicle ahead traveling immediately in front of the vehicle 10, that is, the vehicle ahead closest to the vehicle 10. The identification unit 33 may identify, as the vehicle ahead closest to the vehicle 10, the vehicle ahead which is represented in the object region whose lower end is closest to the lower end of the image among the plurality of vehicles ahead.

The identification unit 33 notifies the lane change control unit 34 of the identification result regarding the lighting state of the lights provided with the vehicle ahead.

The lane change control unit 34 waits without executing lane change control for moving the vehicle 10 from the merging lane to the main lane while the vehicle ahead is detected in the merging lane. On the other hand, when the vehicle ahead is not detected or after the vehicle ahead moves to the main lane, the lane change control unit 34 starts executing the lane change control.

After the vehicle ahead is detected, the lane change control unit 34 determines that the vehicle ahead has moved to the main lane when the vehicle ahead is no longer detected or the lower end of the object region in which the vehicle ahead is represented deviates from the region representing the host lane.

When the execution of the lane change control is started, the lane change control unit 34 sets a planned traveling trajectory that moves from the merging lane to the main lane. At this time, in some embodiments, the lane change control unit 34 sets the planned traveling trajectory so as to move to the main lane at a position near the end of the merging lane (hereinafter, referred to as a target position).

In order to set the planned traveling trajectory, the lane change control unit 34 predicts, for each other vehicle traveling in the main lane, the position and speed of the other vehicle at each time until the other vehicle reaches the end of the merging section (hereinafter, simply referred to as the end position). Then, the lane change control unit 34 sets, in a time zone in which the vehicle 10 can reach the end of the merging section when the change in the speed of the vehicle 10 is within the allowable range, a position at which it is predicted that a space in which the vehicle 10 can enter within a predetermined distance (for example, several meters to several tens of meters) from the end of the merging section will be created as a target position. Further, the lane change control unit 34 sets, as the target vehicle, another vehicle that will travel immediately in front of the vehicle 10 when the vehicle 10 enters the main lane at the target position.

Furthermore, in some embodiments, when the vehicle ahead has been detected, the lane change control unit 34 sets the planned traveling trajectory such that the vehicle 10 enters the main lane immediately behind the other vehicle traveling immediately behind the vehicle ahead when the vehicle ahead moves to the main lane so as to become a zipper merge. Therefore, in this case, the lane change control unit 34 identifies, as the target vehicle, the other vehicle that travels immediately behind the vehicle ahead based on the position of the vehicle ahead when the vehicle ahead moves to the main lane and the position of each other vehicle. For example, when the vehicle ahead moves to the main lane, the lane change control unit 34 identifies, as the target vehicle, the other vehicle that is closer than the vehicle ahead from the vehicle 10 and has the longest relative distance from the vehicle 10 among the other vehicles located in front of the vehicle 10. Then, the lane change control unit 34 may set the target position such that the vehicle 10 enters the space between the specified target vehicle and the other vehicle traveling immediately behind the target vehicle.

When there is a space in which the vehicle 10 can enter between the vehicle ahead and the target vehicle when the vehicle ahead moves to the main lane, the lane change control unit 34 may set the target position such that the vehicle 10 enters the space between the vehicle ahead and the target vehicle.

The lane change control unit 34 may predict the speed and the position of the other vehicle at each time in the future, assuming that the speed of the other vehicle changes in accordance with uniformly accelerated motion. Note that the acceleration includes deceleration. That is, if the value of acceleration is a negative value, the other vehicle decelerates, and if the value of acceleration is a positive value, the other vehicle accelerates. The lane change control unit 34 estimates the current speed and acceleration of the other vehicle by approximating the change in the estimated position of the other vehicle at the generation time of each image or each ranging signal in which the other vehicle is detected, which is obtained within the latest certain period, by assuming that the other vehicle is moving at a constant acceleration. The lane change control unit 34 can predict the speed and the position of the other vehicle at each time in the future by applying the estimated speed and acceleration to the formula of uniformly accelerated motion.

As described above, the position of the lower end of the other vehicle in the image corresponds one-to-one to the azimuth to the position where the other vehicle is in contact with the road surface as viewed from the camera 2. Therefore, the lane change control unit 34 can estimate the distance and the azimuth from the vehicle 10 to the other vehicle based on the position of the lower end of the region in which the other vehicle is represented on the image and the parameters of the camera 2 such as the installation height and the focal length of the camera 2. When the other vehicle is detected from the ranging signal, the lane change control unit 34 can estimate the distance and the azimuth from the vehicle 10 to the other vehicle from the azimuth and the distance at which the other vehicle is represented in the ranging signal. Then, the lane change control unit 34 can estimate the position of the other vehicle at the time of generation of each image or each ranging signal based on the position of the vehicle 10 and the distance and azimuth to the other vehicle as viewed from the vehicle 10 at the time of generation of each image or each ranging signal in the latest certain period. Further, the lane change control unit 34 uses the position of the vehicle 10 represented by the latest positioning information obtained by GPS receiver 3 as the position of the vehicle 10 used for estimating the position of the other vehicle. Alternatively, as described in the lane determination unit 31, the lane change control unit 34 may determine the position of the vehicle 10 by matching the image with the map information, or may acquire the position of the vehicle 10 from the lane determination unit 31.

When a plurality of other vehicles traveling in the main lane are detected, the lane change control unit 34 applies a predetermined tracking method such as KLT tracking or ByteTrack to each object region in which any of the other vehicles is represented in the latest image. As a result, for each object region in the latest image, the lane change control unit 34 associates the other vehicle represented in the object region with the object region in which the same other vehicle is represented, the same other vehicle being detected in the previously obtained image (hereinafter, referred to as a past image) and being tracked. The lane change control unit 34 may track individual other vehicle by repeating the above processing every time the detection result of the other vehicle is notified.

When the target position is set, the lane change control unit 34 refers to the predicted time when the target vehicle will reach the target position, the distance from the current position of the vehicle 10 to the target position, and the current speed of the vehicle 10. Then, assuming that the vehicle 10 performs uniformly accelerated motion, the lane change control unit 34 sets the target acceleration of the vehicle 10 so that the vehicle 10 reaches a position separated by a predetermined offset distance behind the target vehicle at a predicted time when the target vehicle passes the target position.

When the target acceleration and the planned traveling trajectory to the target position are set, the lane change control unit 34 controls each unit of the vehicle 10 so that the vehicle 10 travels along the planned traveling trajectory and the vehicle 10 accelerates or decelerates at the target acceleration, thereby moving the vehicle 10 to the main lane. That is, the lane change control unit 34 controls the steering angle of the steering so that the vehicle 10 does not deviate from the planned traveling trajectory. In addition, the lane change control unit 34 controls the powertrain and the brake so that the actual acceleration of the vehicle 10 approaches the target acceleration. When the vehicle 10 moves to the main lane, the lane change control unit 34 ends the lane change control.

In a case where the vehicle ahead remains in the merging lane for a predetermined period or longer, there is a possibility that the vehicle ahead does not move to the main lane for some reason. Therefore, when the vehicle ahead remains in the merging lane for the predetermined period or longer, the lane change control unit 34 may start the execution of the lane change control. Note that the predetermined period may be a period obtained by multiplying the estimated time required for traveling from the entry point to the end point of the merging section at the average value of the speeds of the other vehicles traveling in the main lane when the vehicle 10 enters the merging section by a predetermined coefficient (for example, 1.2 to 1.5).

Further, when the hazard lights of the vehicle ahead are lit or the brake lights of the vehicle ahead remain off for a predetermined period, the vehicle ahead is stopped or is expected to stop in the merging lane. Therefore, in such a case, even if the vehicle ahead remains in the merging lane, the lane change control unit 34 may start the execution of the lane change control. The predetermined period relating to the continuation of the turn-off state of the brake lights may be shorter than the predetermined period in which the vehicle ahead remains in the merging lane.

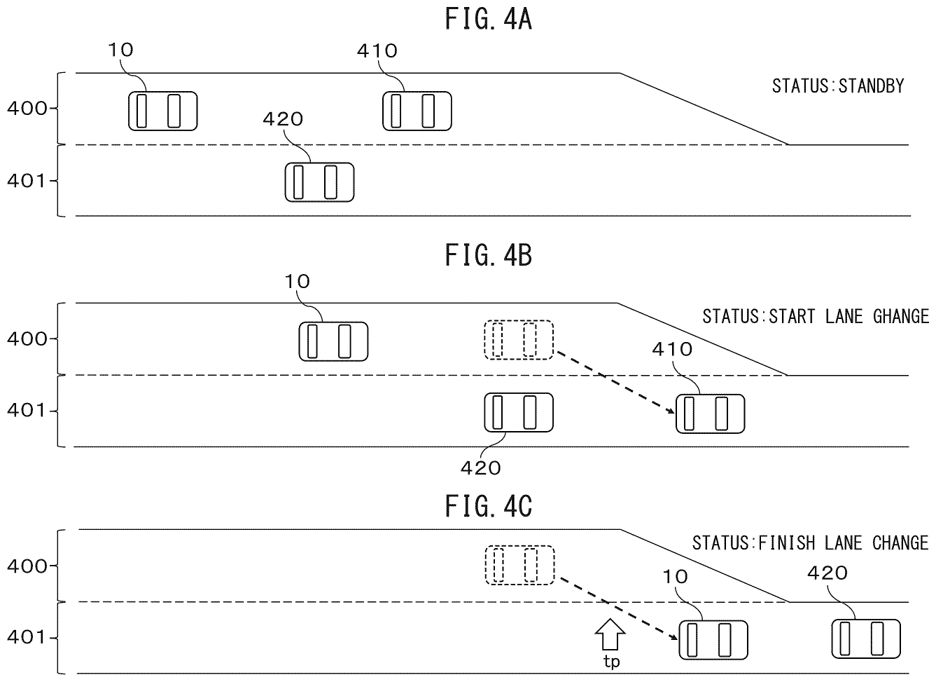

FIGS. 4A to 4C are schematic explanatory diagrams of the vehicle control process according to the present embodiment. In this example, the vehicle 10 and the vehicle ahead 410 are traveling in the merging lane 400, and the other vehicle 420 is traveling in the main lane 401. At the time shown in 4A, since the vehicle ahead 410 is traveling in the merging lane 400, the lane change control of the vehicle 10 is not executed and is in a standby state.

At the time shown in 4B, the vehicle ahead 410 has moved to the main lane 401 in front of the other vehicle 420. Therefore, the lane change control of the vehicle 10 is started. As shown in 4C, when the lane change control of the vehicle 10 is executed, the vehicle 10 moves to the main lane 401 at the target position tp in the vicinity of the end of the merging lane 400 so as to follow the other vehicle 420 traveling immediately behind the vehicle ahead 410.

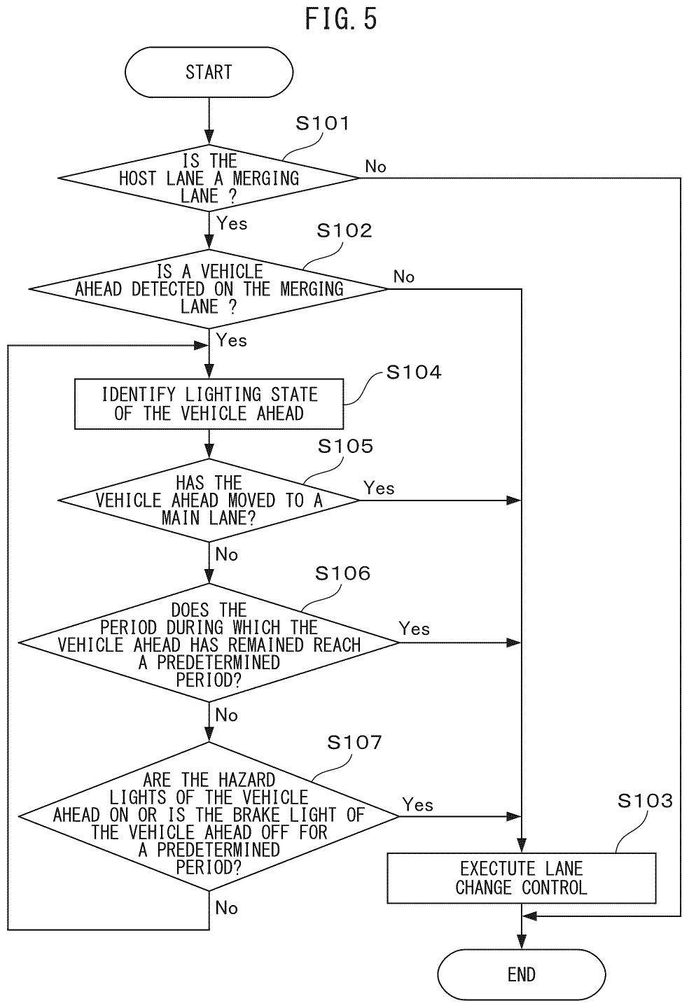

FIG. 5 is an operation flowchart of the vehicle control process executed by the processor 23. When the vehicle 10 enters the merging section, the processor 23 executes the vehicle control process according to the following operation flowchart.

The lane determination unit 31 determines whether or not the host lane in which the vehicle 10 is traveling is a merging lane (step S101). When the host lane is not the merging lane (S101—No in steps), the processor 23 ends the vehicle control process. On the other hand, when the host lane is a merging lane (step S101—Yes), the detecting unit 32 detects a vehicle ahead traveling in the merging lane (step S102). When the vehicle ahead traveling in the merging lane is not detected (step S102—No), the lane change control unit 34 starts executing the lane change control for moving the vehicle 10 from the merging lane to the main lane (step S103).

When the vehicle ahead is detected (step S102—Yes), the identification unit 33 identifies the lighting state of the lights of the vehicle ahead (step S104). Further, the lane change control unit 34 determines whether or not the vehicle ahead has moved from the merging lane to the main lane (step S105). When the vehicle ahead has moved to the main lane (step S105—Yes), the lane change control unit 34 starts executing the lane change control (step S103).

On the other hand, when the vehicle ahead remains in the merging lane (step S105—No), the lane change control unit 34 determines whether or not the period during which the vehicle ahead remains in the merging lane has reached a predetermined period (step S106). When the period in which the vehicle ahead remains in the merging lane reaches the predetermined period (step S106—Yes), the lane change control unit 34 starts executing the lane change control (step S103). In addition, when the period in which the vehicle ahead remains in the merging lane does not reach the predetermined period (step S106—No), the lane change control unit 34 determines whether the vehicle ahead is turning on the hazard lights or keeping the brake lights off for a predetermined period (step S107).

When the vehicle ahead is turning on the hazard lights or the brake lights remains off for the predetermined period (step S107—Yes), the lane change control unit 34 starts executing the lane change control (step S103). On the other hand, when the period during which the vehicle ahead turns off the brake lights has not reached the predetermined period and the hazard lights has not been turned on (step S107—No), the processor 23 repeats the process from step S104 and the subsequent steps.

As described above, the vehicle control device waits for execution of the lane change control until the vehicle ahead traveling in the merging lane moves to the main lane and starts execution of the lane change control when the vehicle ahead has moved to the main lane. Therefore, the vehicle control device can cause the host vehicle to perform zipper merge.

According to a modification, the vehicle 10 may be provided with the camera 2 that captures an image of the front region of the vehicle 10 and the camera 2 that is directed toward the rear of the vehicle 10 so as to generate a rear image representing the rear region of the vehicle 10. The detection unit 32 may detect a following vehicle traveling behind the vehicle 10 from the rear image by executing the same processing as in the above-described embodiment on the rear image. Further, the lane change control unit 34 may calculate an average value of the speeds of the individual other vehicles traveling in the main lane, and determine that the main lane is congested when the average value is equal to or less than a predetermined congestion determination threshold value. The congestion determination threshold value may be a value obtained by multiplying the maximum speed represented in the map information in the merging section in which the vehicle 10 is traveling by 0.4 to 0.6. When the main lane is congested and no following vehicle is detected, the lane change control unit 34 may set the target position at which the vehicle 10 moves from the merging lane to the main lane, not only in the vicinity of the end of the merging section but also in an arbitrary position in the merging section. For example, the lane change control unit 34 may set the planned traveling trajectory so as to move to the main lane immediately behind the other vehicle preceding the vehicle 10 and closest to the vehicle 10 among the individual other vehicles traveling in the main lane when it is determined that the lane change control is started. When the following vehicle is detected, the lane change control unit 34 sets a target position in the vicinity of the end of the merging section as in the above-described embodiment. According to this modification, in a case where there is no following vehicle, the vehicle control device can more smoothly change the lane in which the host vehicle is traveling.

According to another modification, the lane change control unit 34 may determine the timing at which the lane change control is started without referring to the lighting state of the lights of the vehicle ahead. In this case, the processing of the identification unit 33 may be omitted.

Further, the computer program that achieves the functions of the processor 23 of the ECU 5 according to the above-described embodiment or modification may be provided in a form recorded in a computer-readable portable recording medium such as a semiconductor memory, a magnetic recording medium, or an optical recording medium.

As described above, a skilled person can make various modifications according to the embodiment within the scope of the present disclosure.

What is claimed is:

1. A vehicle control device comprises:
a processor configured to:
determine whether or not a host lane in which a host vehicle is traveling is a merging lane merging with a main lane,
detect a vehicle ahead traveling in front of the host vehicle in the merging lane when the host lane is the merging lane,
wait for execution of lane change control for moving the host vehicle from the merging lane to the main lane while the vehicle ahead is detected in the merging lane, and
execute the lane change control when the vehicle ahead is not detected or after the vehicle ahead moves to the main lane.

2. The vehicle control device according to claim 1, wherein the processor starts execution of the lane change control when the vehicle ahead traveling in the merging lane is detected and the vehicle ahead remains in the merging lane for a predetermined period.

3. The vehicle control device according to claim 1, wherein the processor is further configured to identify a lighting state of lights provided with the vehicle ahead, wherein
when hazard lights of the vehicle ahead are lit or brake lights of the vehicle ahead remain off for a predetermined period, the processor starts execution of the lane change control even when the vehicle ahead remains in the merging lane.

4. The vehicle control device according to claim 1, wherein the processer is further configured to detect a following vehicle which is traveling behind the host vehicle in the merging lane, wherein
the processor executes the lane change control so that the host vehicle moves to the main lane at a target position within a predetermined distance from an end of the merging lane when the main lane is congested and the following vehicle is detected, and the processor executes the lane change control so that the host vehicle moves to the main lane at any position that the host vehicle can move from the merging lane to the main lane when the main lane is not congested or the following vehicle is not detected.

5. A non-transitory recording medium that stores a computer program for controlling a vehicle, the computer program causing a processor mounted on a host vehicle to execute a process comprising:
determining whether or not a host lane in which the host vehicle is traveling is a merging lane merging with a main lane;
detecting a vehicle ahead traveling in front of the host vehicle in the merging lane when the host lane is the merging lane;
waiting for execution of lane change control for moving the host vehicle from the merging lane to the main lane while the vehicle ahead is detected in the merging lane; and
executing the lane change control when the vehicle ahead is not detected or after the vehicle ahead moves to the main lane.
